(19) United States
(12) Patent Application Publication
(10) Pub. No.: US 2012/0069476 A1
(43) Pub. Date: Mar. 22, 2012

(54) Thermally protected resettable GFCI

(76) Inventor: Steve Fabian, Port Jefferson, NY (US)

(21) Appl. No.: 13/136,798

(22) Filed: Aug. 10, 2011

Related U.S. Application Data
(60) Provisional application No. 61/401,277, filed on Aug. 10, 2010.

(51) Int. Cl. H02H 9/08; H02H 3/02

(52) U.S. Cl. 361/42

(57) ABSTRACT

An improved GFCI monitors the balance of current passing through the device, and as long as the difference between current coming in and going out stays within a given range, normally 5 ma, the device remains in the active setting. If sensed current does not remain in balance, or within the given range, a voltage source is generated, signaling the comparator/controller to trip a solenoid. A solenoid trip results in disconnection of both line and neutral on the face contacts, with power being shut off to the load, and with the load terminals disconnecting all receptacles downstream. A mechanical or electronic switch, being located across the SCR, is activated by a thermal sensor detecting abnormal temperatures, which may also trigger the solenoid, in addition to it being triggered when leakage is detected. The sensors can be placed directly on to the surfaces to be monitored for maximum heat transfer.

### CROSS REFERENCES TO RELATED APPLICATIONS

This application claims priority on U.S. Provisional Application Ser. No. 61/401,277 filed on Aug. 10, 2011, the disclosures of which are incorporated herein by reference.

### FIELD OF THE INVENTION

The present invention relates to improvements in Ground Fault Circuit Interrupters (GFCIs), and more particularly to interrupters which are capable of providing a combination of surge and heat protection to receptacles.

### BACKGROUND OF THE INVENTION

The use of electrical power, through wiring and related components, had originally been in accordance with many conflicting standards, but New York, around 1881, established electrical codes to regulate installations of lighting. Since 1897, a private, non-profit organization formed by insurance companies—the National Fire Protection Association (NFPA)—began publishing the National Electric Code (NEC). The NEC comprises a consensus of opinions on electrical safety codes, and proposals for changes to be made thereto are considered by code-making panels and in committees consisting of engineers, tradesmen, manufacturer representatives, firefighters, and others. The NEC is updated every three years, with the 2008 version being the latest. The NEC is approved as an American standard by the American National Standards Institute (ANSI), and is formally identified as ANSI/NFPA 70. Although the NEC is not by itself U.S. law, regulations enacted by cities, counties, and states regarding building codes are often taken verbatim from the NEC, or are only slightly modified therefrom.

Article 210.8 of the NEC addresses the use, in branch circuits, of a Ground Fault Circuit Interrupter (GFCI) for the protection of personnel. The article cites nine locations (210.9(A)(1)-(9)) within an occupancy where GFCIs are required for electrical sockets, and generally includes wet areas within bathroom and kitchen areas, as well as certain crawl-space locations, garages, boathouses, and unfinished basements. A GFCI serves to prevent electrical damage to equipment, and severe or fatal electric shocks to persons. Proper deployment of GFCIs within dwellings and commercial buildings would prevent about two-thirds of the roughly 300 accidental electrocutions that occur annually in the United States.

The forerunner of today's GFCI was disclosed by U.S. Pat. No. 3,213,321 to Dalziel for “Miniature Differential Circuit Breaker,” with improvements made thereafter, including U.S. Pat. No. 3,852,642 to Engel for “Sensing Amplifier and Trip Circuit Particularly for Ground Fault Circuit Interrupter,” and U.S. Pat. No. 4,345,289 to Howell for “Ground Fault Circuit Interrupting Device With Improved Thyristor Triggering.”

A GFCI is similar in function to that of circuit breakers and fuses, but whereas a circuit breaker detects a fault condition when the “hot” current exceeds a fixed value for a fixed time, after which it breaks the circuit's continuity, a GFCI will interrupt the current when it detects current “leaking” to ground, either directly or through the resistance of a person. The GFCI senses any loss of current by recognizing an imbalance between the current in the “hot” side, and the current in the “neutral” side, and monitors the balance using a differential current transformer. GFCIs are designed to interrupt current flow within 25-40 milliseconds, which would limit the shock accidentally received to be less than the duration that may normally be needed to drive the victim's heart into ventricular fibrillation, the common cause of death where electric shock has occurred. The NEC requires circuit interruption where the current leakage exceeds a range of 4-6 milliamperes (normally a 5 mA trip setting is used) when protecting people, and it may be as high as 30 mA when protecting equipment.

However, as electrical energy is transported through a circuit—circuitry comprising electrically insulated wires and components—the movement of electrons therein produces a temperature rise in both the conductor and any insulation utilized. While wiring materials typically dictated by NEC to be copper—tend to have very high melting temperatures, being around 1,980 degrees Fahrenheit, the insulation utilized typically melts around 300 degrees Fahrenheit. This phenomenon is exacerbated by voltage surges, against which protection is generally provided by a thermal magnetic circuit breaker, which uses a bimetallic strip responding to less extreme but longer-term over-current conditions. The bimetallic strip utilized is called a varistor. A varistor is specially constructed to exhibit a significant nonlinear current-voltage characteristic, having a high resistance at low voltages and a low resistance at high voltages, with the most common varistor being a metal oxide varistor (MOV). Improvements to the use of a MOV in a GFCI circuit was shown by U.S. Pat. No. 4,345,289 to Howell,

There are some prior art GFCI designs addressing the problem of fires that were believed to be caused by overloaded electrical outlets, overloads that may be caused by a loose connection, a glowing connection and/or a high resistance path. A glowing connection may occur when copper oxide is formed between a copper wire and a steel screw in a small air gap creating carbon which glows. One such invention is shown by U.S. Pat. No. 4,951,025 to Finnegan for “Thermally Monitored Electrical Outlet Receptacle Apparatus.” However, the invention disclosed herein provides a means of thermal protection and current interruption by using sensors to trip the GFCI solenoid, as hereinafter described.

### OBJECTS OF THE INVENTION

It is an object of the invention to provide a switch feature across a control SCR, which may cause a GFCI solenoid to trip when abnormal temperatures are detected.

It is also an object of the invention to provide a temperature sensing means of GFCI activation for either a plug-in adaptor or a receptacle.

### SUMMARY OF THE INVENTION

The device comprises of a GFCI receptacle with a thermal cutoff feature. When there is an imbalance in the current sensing transformers, the controller/comparator senses the imbalance, turning on the SCR, which drives the solenoid. By simply switching across the SCR, either by a mechanical thermal switch or an electronic switch, one can turn on the solenoid at a preset temperature. This will disconnect the load from the face as well as downstream, eliminating any possible current draw, and eliminating any possible heating that may have resulted. The device can be made, so that when the temperature falls back below the threshold, the switch will turn back off and the device could operate as normal. It can also be set so that the GFCI is a one shot, in which the thermal sensor does not go back to its original position.

### BRIEF DESCRIPTION OF THE DRAWINGS

FIG. 1 is a perspective view of a GFCI of the current invention.

FIG. 1A is a reverse perspective view of a GFCI of FIG. 1.

FIG. 2 is a schematic diagram of the electrical circuit of the GFCI of FIG. 1.

FIG. 3 is a schematic diagram of a GFCI circuit, identifying a circuit location for a switch feature usable for connecting the solenoid in the circuit of FIG. 2.

FIG. 4 is a detailed circuit schematic of the electronic switch circuit.

### DETAILED DESCRIPTION OF THE INVENTION

A ground fault circuit interrupter (GFCI) is an electrical device that works to de-energize a circuit upon detection of abnormal current flow, such as current “leaking” to ground—through a direct “ground fault,” or through the resistance of a person. A ground fault condition may exist when there is a current imbalance between the current-carrying phase and neutral, where the imbalance is above a designated threshold specified in the particular electrical code.

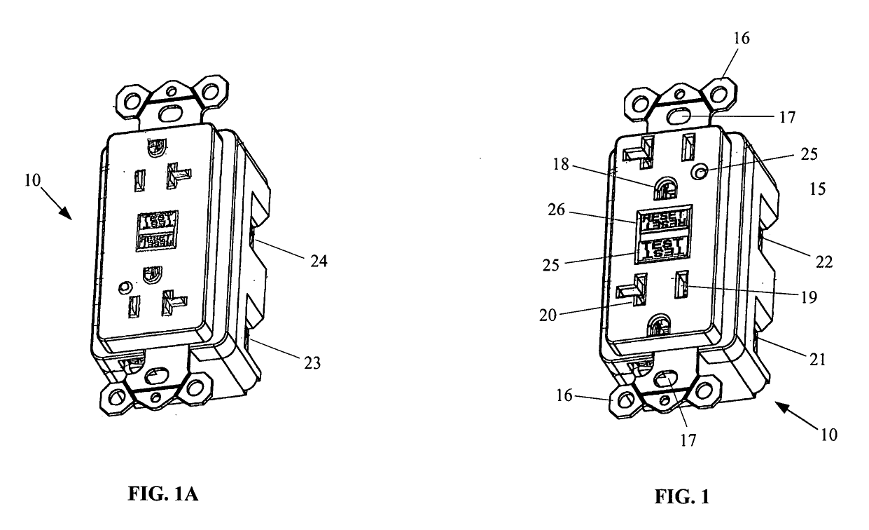

FIG. 1 shows a GFCI of the current invention. It should be noted that this invention incorporates certain elements from the commonly held U.S. Pat. No. 7,489,227 for “Electrical Receptacle with Multiple Heat Sensors,” and U.S. Pat. No. 7,385,473 for One-Shot Heat Sensing Electrical Receptacle,” the disclosures of which are incorporated herein by reference; however, neither offers the GFCI features and protection of the current invention.

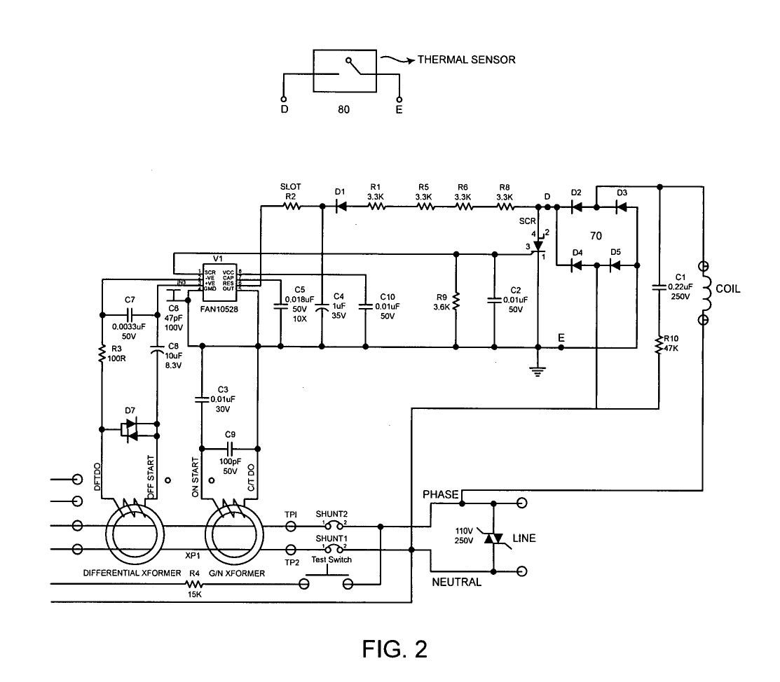

A typical GFCI 10 may comprise a housing 15 that provides support for the requisite circuitry, and an installation means for installation of the GFCI within an electrical outlet box. The installation means may comprise flanges 16 protruding out from the housing 15, with a screw being retained in an orifice 17 in each flange 16, thereby making the flanges 16 of GFCI 10 securable to the electrical outlet box (not shown) in the wall of a dwelling or commercial building. The housing 15 of the GFCI 10 may comprise one or more neutral terminals (23, 24), a load terminal 22, and a hot terminal 21, each of which may be in the form of a screw, and have electrical connections according to the schematic circuit diagram of FIG. 2. The wiring within the electrical outlet box may thereby be connectable to the terminals 21-24 to enable the power supply to the standard U.S. socket, which is capable of receiving a plug, and which has a rounded ground receptacle 18, a rectangular receptacle 19 for connection to the hot terminal, and a slightly larger rectangular receptacle 20 for connection to the neutral terminal. A test button 25 can be actuated to test the operation of the circuit-interrupting portion of the present device. A reset button 26, may be used to activate a reset operation, which reestablishes the electrical continuity in the open conductive paths.

Many fires are believed to be caused by overloaded electrical outlets, that is, outlets operated with more power transfer than the outlet was designed for. Fires are sometimes caused by a loose connection, a glowing connection, and/or a high resistance path. A glowing connection may occur when copper oxide is formed in a small air gap between a copper wire and a screw creating carbon which may glow. The condition of too much power usage is always accompanied by increased temperature in at least one of the following: the ambient temperature, the receptacle temperature, and the temperature of a prong of an electrical plug inserted into the receptacle. It is also possible that voltage surges may occur regularly, but are of insufficient amplitude to cause a trip, but serve to increase temperatures, which may cause fires. To avoid hazardous condition capable of leading to fires, it is desirable for the GFCI to sense when operating temperatures are excessive, and to cease operation by de-energizing the circuit. Electrical codes also usually mandate a maximum amount of time after which the unit must trip in response to a ground fault.

As seen in FIG. 2, the invention herein adds a switch 80 across the rectifier bridge 70, at points D and E. The switch 80 may be coupled to one or more thermal sensors 81 that may be placed directly on the surface being monitored for maximum heat transfer—surfaces which may comprise each of the terminal screws 21, 22, 23, and 24. The solenoid, which is normally activated by the control circuit when current leakage is detected, may thus also be independently controlled to trip when an abnormal temperature is detected, thereby disconnecting both line and neutral on the face of the contacts, and the load terminals connecting all receptacles downstream.

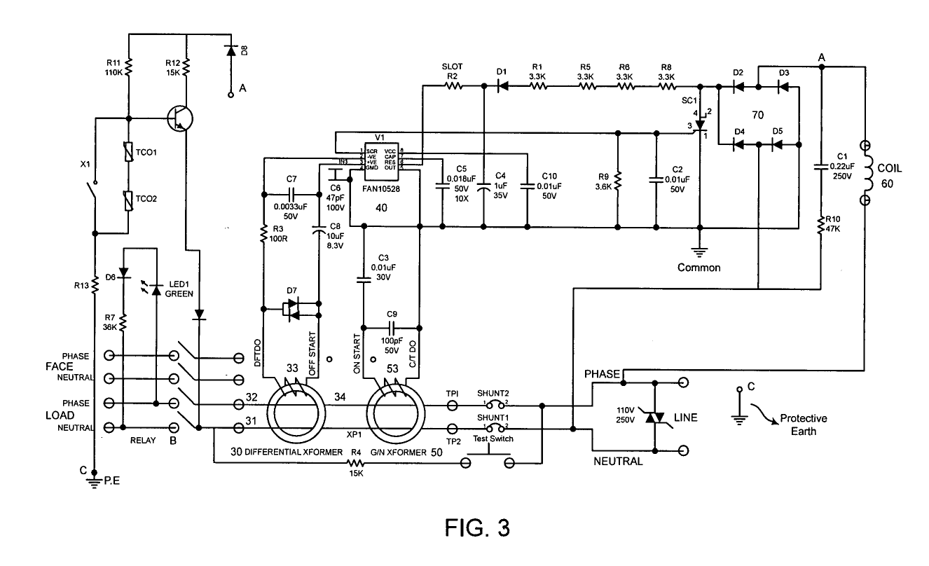

As seen in the circuit schematic of FIG. 3, in an alternate embodiment, the GFCI circuit may comprise a differential current transformer 30, which is also commonly referred to as the “ground fault” or the “sense” transformer. The differential current transformer 30 may have a toroidal core with primary conductors, which may comprise a hot conductor 32 that may be connected through a switch to receive the AC phase supply, and a neutral conductor 31 that may be connected through a switch to the neutral connector on the AC supply side. A plurality of secondary sense windings 33 may be provided on the core 34 for sensing an imbalance in the conduction current levels of the primary conductors 31 and 32, which indicates the existence of a ground fault. The ends of the secondary sense windings 33 may run to pins two and three of an eight-pin integrated circuit chip (FAN1852B) 40, and include related burden resistance, bypass capacitor, and dual diodes, as part of sense amplification in a trip circuit.

The circuit of FIG. 3 may also comprise a second current transformer, often referred to as the ground neutral transformer (G/N XFormer) 50, which may be used to detect neutral-to-ground faults, occurring due to miswiring or a short circuit where the neutral and ground wires are connected by a low resistance path downstream of the GFCI. Where this occurs, the GFCI will immediately trip when power is applied, even if no load is connected to the protected circuit. The G/N Transformer 50 may also have a plurality of sense windings 53 provided on the core 54, with the ends of the windings 53 running to pins four and five of the IC chip 40.

The interrupter is actuated when the differential transformer or G/N Transformer senses that more current is flowing into the load from the source through the hot conductor than is flowing back to the source through the neutral conductor.

Interruption of circuit continuity may be by a disconnect solenoid coil 60. The hot line (Phase) of the input side (through primary conductor 31), the solenoid coil 60, and a diode bridge rectifier (D2-D5) circuit 70 are connected in series to form the power supply circuit that supplies power to the GFCI control circuit. The GFCI device may be used in a single phase circuit, such as a single phase 120V AC circuit, or in a polyphase circuit, such as 120/240V AC circuit. A comparator may be used to sense current differential in each of the transformers, and where there is a differential, the comparator may trigger the solenoid.

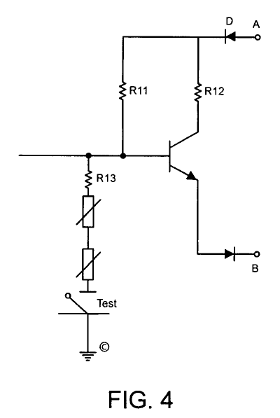

The circuit may further comprise, as seen in FIG. 4, a pair of thermocouples in series with a test switch to simulate temperatures in excess of the requisite thermal threshold to cause a trip by the solenoid.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. An improved ground-fault circuit interrupter device for safely supplying power to an electrical plug, said device comprising:
a housing; said housing comprising an installation means, for use in installing said improved GFCI;
at least one outlet for receiving load and neutral prongs of the electrical plug, the outlet having a female plug prong contact pair for each of the load and neutral prongs,
a load terminal;
two neutral terminals, with each said neutral terminal being adapted to be electrically connected to neutral power lines;
a hot terminal being adapted to be electrically connected to hot power lines;
a solenoid coil and plunger assembly which, when triggered, comprises movement of said plunger causing the contacts of a switch to disconnect, and power to be shut off;
a power supply circuit comprising said solenoid and a diode bridge rectifier being connected in series with said hot terminal;
a differential current transformer being capable of sensing current differences between hot and neutral conductors supplying power, to thereby indicate a ground fault and trigger said solenoid;
a ground neutral transformer being capable of detecting neutral-to-ground faults due to mis-wiring or a short circuit, to thereby trigger said solenoid;
a trip circuit comprising an integrated circuit chip being selectively coupled with said differential current transformer and said ground neutral transformer to provide sense amplification and to trigger said solenoid when a leakage current or a ground fault is detected; and
one or more thermal sensors for sensing temperature at respective locations in said improved ground-fault circuit interrupter device and for detecting temperature greater than a predetermined threshold; and wherein when at least one of said one or more thermal sensors detects temperature greater than the predetermined threshold indicating abnormal heating, said at least one thermal sensor triggers said solenoid.

2. An improved ground-fault circuit interrupter device according to claim 1 wherein said respective locations for said one or more thermal sensors comprises a thermal sensor at each of said terminals.

3. An improved ground-fault circuit interrupter device according to claim 2 wherein said respective locations for said one or more thermal sensors further comprises a thermal sensor at each of said female contacts of said GFCI device.

4. An improved ground-fault circuit interrupter device according to claim 3 wherein each of the thermal sensors comprise a bimetal and an associated spring.

5. An improved ground-fault circuit interrupter device according to claim 4 further comprising a pair of thermocouples in series with a test switch to simulate temperatures in excess of the requisite thermal threshold to cause a test trip by said solenoid.
